(19) United States
(12) Patent Application Publication
(10) Pub. No.: US 2016/0335378 A1
(43) Pub. Date: Nov. 17, 2016

(54) DIRECT MAPPING METHOD AND SYSTEM FOR CONVERTING MODBUS DATA TO IEC61850 DATA BASED ON MACHINE LEARNING

(71) Applicant: Korea Electronics Technology Institute, Seongnam-si (KR)

(72) Inventors: Sang Yub LEE, Yongin-si (KR); Kyung Sun HAM, Yongin-si (KR); Tae Hyoung KIM, Seongnam-si (KR); Jae Kyu LEE, Jeonju-si (KR)

(21) Appl. No.: 15/136,988

(22) Filed: Apr. 25, 2016

(30) Foreign Application Priority Data
May 14, 2015 (KR) 10-2015-0067388

(51) Int. Cl. G06F 17/50; G06N 99/00

(52) U.S. Cl. CPC G06F 17/5009; G06N 99/005

(57) ABSTRACT

Direct mapping method and system for converting MODBUS data into IEC61850 data based on machine learning are provided. The data direct mapping method according to an exemplary embodiment includes: generating a simulation value based on external information; estimating a parameter indicated by a measurement value through machine learning using the measurement value outputted from a generating device and the generated simulation value; and converting a data structure of the measurement value with reference to the estimated parameter. Accordingly, the MODBUS data can be directly converted into the IEC61850 data without data reconversion using a data gateway.

### CROSS-REFERENCE TO RELATED APPLICATION(S) AND CLAIM OF PRIORITY

The present application claims the benefit under 35 U.S.C. §119(a) to a Korean patent application filed in the Korean Intellectual Property Office on May 14, 2015, and assigned Serial No. 10-2015-0067388, the entire disclosure of which is hereby incorporated by reference.

### TECHNICAL FIELD OF THE INVENTION

The present invention relates generally to data direct mapping, and more particularly, to direct mapping method and system for converting MODBUS data into IEC61850 data.

### BACKGROUND OF THE INVENTION

IEC61850 is established to be operated and managed in a system using a standard protocol regardless of the type of device and the type of system.

When a device using a nonstandard MODBUS protocol is connected to an IEC61850-based power management system, direct mapping should be performed using a data gateway to convert MODBUS data into IEC61850 data, and the IEC61850 data should be transmitted to a Supervisory Control And Data Acquisition (SCADA) system of a Human Machine Interface (HMI) computer as shown in FIG. 1.

That is, a server and a client related to OLE for Process Control (OPC) of the data gateway should be added.

A data processing process in the system shown in FIG. 1 is illustrated in FIG. 2. As shown in FIG. 2, data outputted from the MODBUS device is changed to be suitable for the OPC configuration, is converted into IEC61850 data in an IEC61850 interpreter and is then transmitted to the HMI computer.

When the device using the nonstandard MODBUS protocol is added to the IEC61850-based power management system, many additional procedures are required in view of software processing, and additional equipments are required in view of hardware configuration.

Accordingly, there are problems that the cost for establishing a system increases, the cost for adding software occurs, and the cost for maintaining and repairing a network increases when a problem arises.

### SUMMARY OF THE INVENTION

To address the above-discussed deficiencies of the prior art, it is a primary aspect of the present invention to provide direct mapping method and system for converting MODBUS data into IEC61850 data based on machine learning, which can reduce the cost for software/hardware when a MODBUS device is added to an IEC61850 system.

According to one aspect of the present invention, a data direct mapping method includes: generating a simulation value based on external information; estimating a parameter indicated by a measurement value through machine learning using the measurement value outputted from a generating device and the generated simulation value; and converting a data structure of the measurement value with reference to the estimated parameter.

The external information may include at least one of environment information and a system condition.

The estimating may include: comparing a pattern of the measurement value and a pattern of the simulation value; and estimating, as the parameter of the measurement value, a parameter indicated by a simulation value having highest pattern similarity, which is above a reference value, with respect to the measurement value.

The data direct mapping method may further include, when there is no simulation value having pattern similarity higher than the reference value with respect to the measurement value, re-generating a simulation value of machine learning and re-estimating a parameter.

The re-generated simulation value may be re-generated by making change to the external information which is used for the already generated simulation value.

The converting may include converting a data structure of the measurement value into a data structure which is defined in a standard for the estimated parameter.

The data direct mapping method may further include: receiving a command; grasping a corresponding parameter based on contents of the received command; and converting a format of the command with reference to the grasped parameter.

According to another aspect of the present invention, a data direct mapping system includes: a generation unit configured to generate a simulation value based on external information; a sorting unit configured to estimate a parameter indicated by a measurement value through machine learning using the measurement value outputted from a generating device and the simulation value; and a direct mapping unit configured to convert a data structure of the measurement value with reference to the estimated parameter.

According to exemplary embodiments of the present invention as described above, the MODBUS data can be directly converted into the IEC61850 data without data reconversion using a data gateway.

In addition, according to exemplary embodiments of the present invention, an OPC client/server for data direct mapping may be omitted and thus additional software is not required.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a view showing a configuration of a related-art IEC61850/MODBUS integrated system;

FIG. 2 is a view showing a data processing process in the system of FIG. 1;

FIG. 3 is a view to illustrate a concept of data direct mapping in a new regeneration energy system;

FIG. 4 is a view showing a method for converting a MODBUS frame into an IEC61850 frame;

FIG. 5 is a table in which the order of parameters is rearranged for data direct mapping;

FIGS. 6 to 8 are graphs showing measurement values;

FIG. 9 is a graph showing simulation values generated regarding grid voltage, rotor speed, real power, and reactive power;

FIG. 10 is a view showing a data direct mapping system according to an exemplary embodiment of the present invention;

FIG. 11 is a view to illustrate a process of re-direct mapping a control command;

FIG. 12 is a graph comparing patterns of a simulation value and a measurement value regarding a Q factor when external information is not considered; and

FIG. 13 is a graph comparing patterns of a simulation value and a measurement value regarding a Q factor when wind direction information is considered as external information.

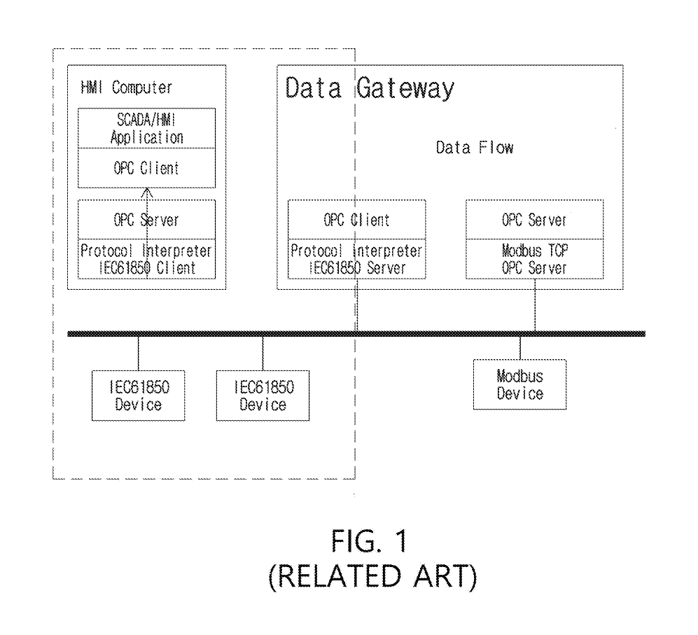

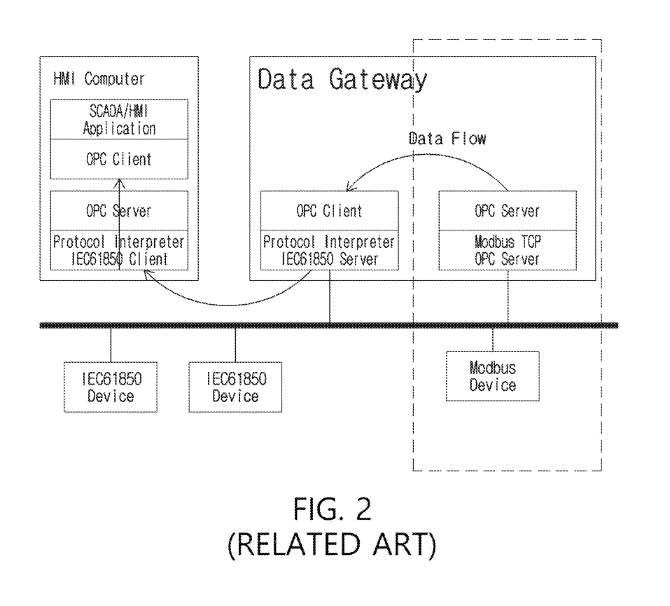

### DETAILED DESCRIPTION OF THE INVENTION

Reference will now be made in detail to the embodiment of the present general inventive concept, examples of which are illustrated in the accompanying drawings, wherein like reference numerals refer to the like elements throughout. The embodiment is described below in order to explain the present general inventive concept by referring to the drawings.

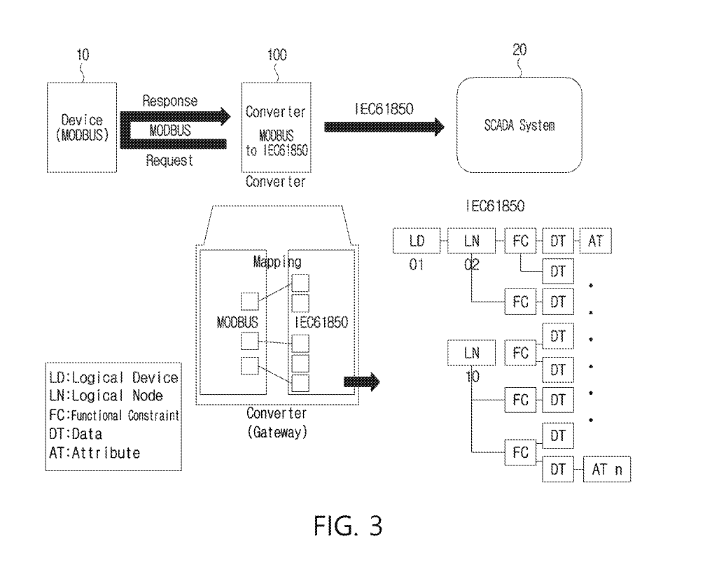

FIG. 3 is a view to illustrate a concept of data direct mapping in a new-regeneration energy (wind power, wave power, solar power energy) system. FIG. 3 schematically illustrates a system and a process for converting an MODBUS frame into an IEC61850 frame.

As shown in FIG. 3, the data direct mapping system 100 requests/receives an MODBUS frame from an MODBUS device 10 of a new regeneration energy generating device, converts the received MODBUS frame into an IEC61850 frame, and transmits the IEC61850 frame to an SCADA system 20.

The configuration of the MODBUS frame is illustrated in the left lower view of FIG. 3 and the configuration of the IEC61850 frame is illustrated in the right lower view of FIG. 3.

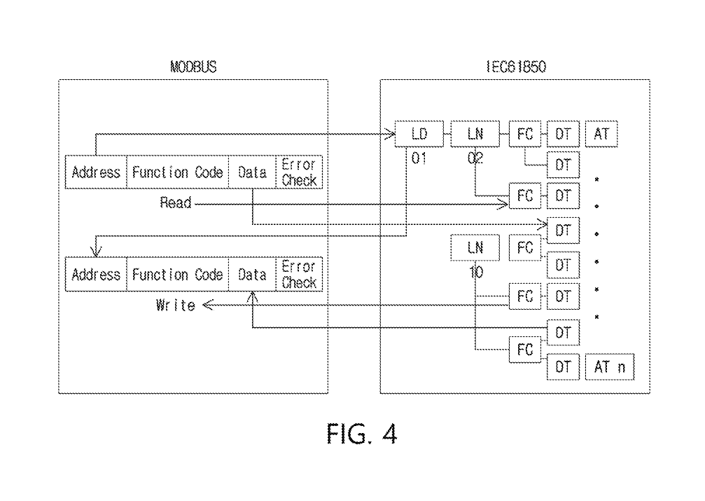

FIG. 4 illustrates a method for converting the MODBUS frame into the IEC61850 frame. A data part is the most important thing in the direct mapping process of FIG. 4. That is, it is most important to convert the MODBUS data into the IEC 61850 data.

According to an exemplary embodiment of the present invention, direct mapping is performed based on machine learning to convert the MODBUS data into the IEC61850 data. That is, related-art server and client related to the OLE for Process Control (OPC) are not used.

The MODBUS data received from the MODBUS device 10 includes a parameter, a data type, an address, etc. However, all of the MODBUS data does not have the same configuration and the order of parameters and the configuration of the addresses for processing the parameters may vary according to the manufacturer which has developed the MODBUS device 10.

According to an exemplary embodiment of the present invention, the order of parameters is rearranged to directly convert the MODBUS data into the IEC61850 data. In addition, parameters of measurement values are estimated based on machine learning using waveforms of measurement values included in the MODBUS data.

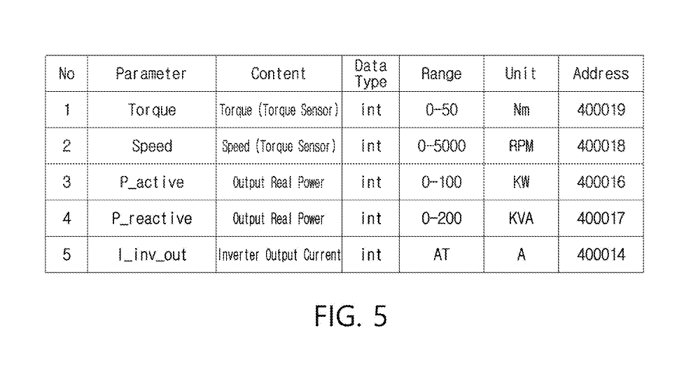

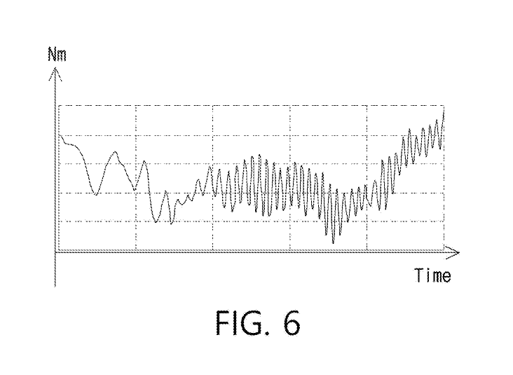

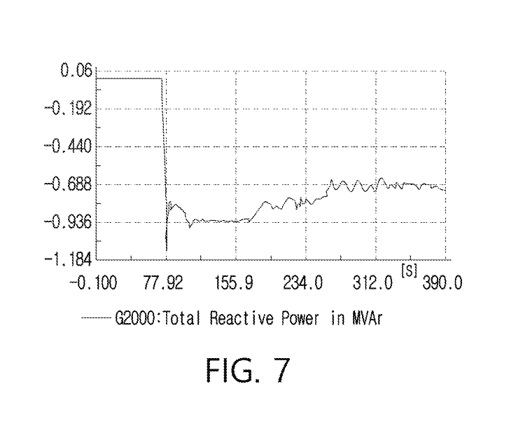

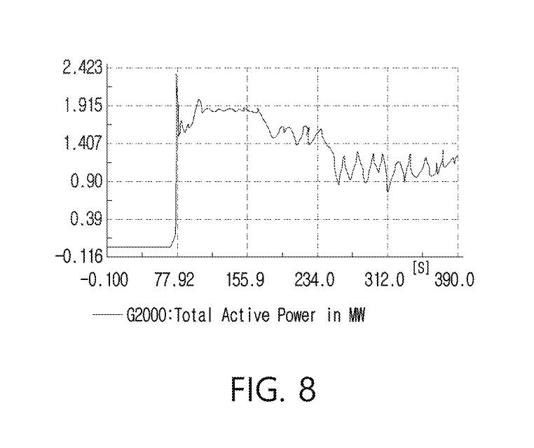

FIGS. 6 to 8 illustrate characteristics of measurement values regarding some of the parameters proposed in FIG. 5. Specifically, FIG. 6 illustrates a change in torque, FIG. 7 illustrates an amount of reactive power, and FIG. 8 illustrates an amount of real power.

Regarding the parameters, simulation values rather than measurement values may be generated. According to an exemplary embodiment of the present invention, to generate the simulation values more exactly, external environment information or a condition of a system for supplying new-regeneration energy (for example, required power) may be reflected.

For example, a simulation value for output power in a wind power generation system may be generated by applying a rotor power coefficient (Cₚ), air density (p), an effective area (A) which is in direct contact with wind when a blade is rotated, and a velocity of wind (V_{wind}) to the following equation:

P_{wind}=0.5CpρAV_{wind}³ Equation 1

In addition, all parameters transmitted from the MODBUS are associated with one another, and the output power is divided into real power and reactive power and simulation values of the real power and the reactive power may be generated using the following equations:

$${V}_{Rms} = {V}_{Rms} {∠θ}_{v} \\ {I}_{Rms} = {I}_{Rms} {∠θ}_{i} \\ \begin{matrix}S = {V}_{Rms} {I}_{Rms} ∠ ( {θ}_{v} - {θ}_{i} ) \\ = {V}_{Rms} {I}_{Rms} cos ( {θ}_{v} - {θ}_{i} ) + j {V}_{Rms} {I}_{Rms} sin ( {θ}_{v} - {θ}_{i} ) \\ = P + j Q \\ = Re \{ S \} + j Im \{ s \} \\ = RealPower + RecactivePower\end{matrix} \qquad Equation 2$$

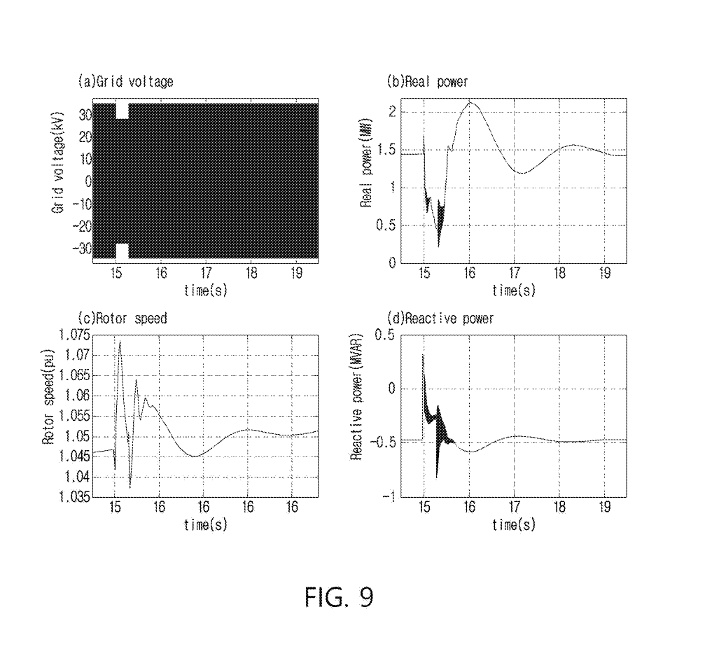

According to an exemplary embodiment of the present invention, the simulation values are generated in this method and FIG. 9 illustrates the results of generating simulation values regarding grid voltage, rotor speed, real power, and reactive power.

The generated simulation values are used as initial values of machine learning. That is, it is estimated which parameter the MODBUS data is related to by comparing the patterns of the measurement values included in the MODBUS data and the patterns of the simulation values.

Specifically, when the MODBUS data is acquired, the measurement values included in the MODBUS data are compared with patterns of the real power simulation values and the reactive power simulation values, and a parameter having a measurement value having the most similar pattern to that of the simulation value is estimated as the parameter of the MODBUS data.

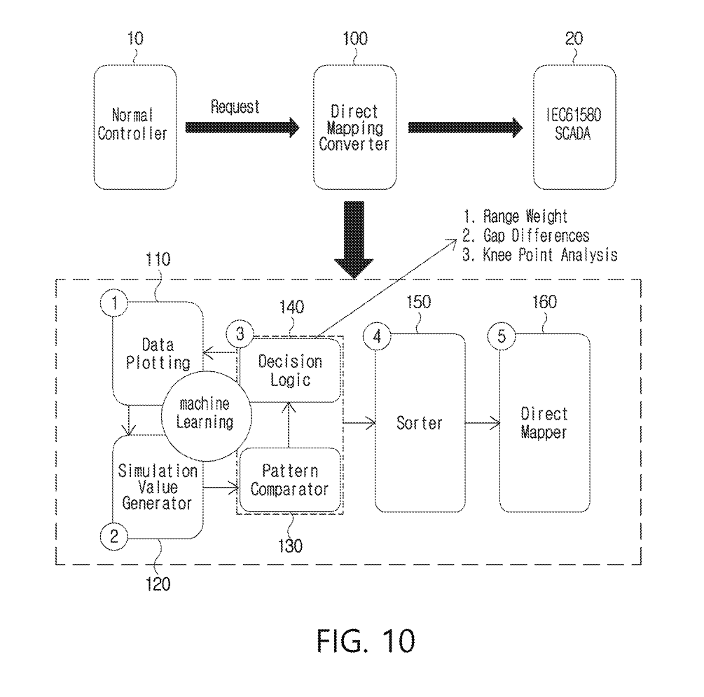

FIG. 10 is a view showing a data direct mapping system according to an exemplary embodiment of the present invention. In FIG. 10, the data direct mapping system (direct mapping converter) 100 receives an MODBUS frame from an MODBUS device 10, converts the MODBUS frame into an IEC61850 frame, and transmits the IEC61850 frame to an SCADA system 20.

To achieve this, the data direct mapping system 100 includes a data plotting unit 110, a simulation value generation unit 120, a pattern comparison unit 130, a decision unit 140, a sorting unit 150, and a direct mapping unit 160.

The data plotting unit 110, the simulation value generation unit 120, the pattern comparison unit 130, and the decision unit 140 are configured for machine learning.

The data plotting unit 110 plots measurement values recorded on the MODBUS data, and generates the results as shown in FIGS. 6 to 8.

In addition, the simulation value generation unit 120 generates simulation values regarding parameters (torque, velocity, real power, reactive power, current, voltage, etc.) based on environment information such as wind condition information, system condition information, etc.

The pattern comparison unit 130 compares the patterns of the measurement values generated by the data plotting unit 110 and the patterns of the simulation values generated by the simulation value generation unit 120. Based on the result of the comparing by the pattern comparison unit 130, the decision unit 140 generates similarity between the measurement values and the simulation values.

To achieve this, the pattern comparison unit 140 may extract distinguishing parts from the measurement value and the simulation value, calculate a difference in the patterns (that is, a difference between the measurement value and the simulation value) from the extracted parts, compare locations in the knee points, and transmit the result of the comparing to the decision unit 140. The decision unit 140 decides the similarity between the measurement value and the simulation value by combining the results of the comparing.

The sorting unit 150 estimates the parameter of the measurement value based on the similarity decided by the decision unit 140. Specifically, a parameter having the highest similarity is estimated as the parameter of the measurement value. For example, when the measurement value has the highest pattern similarity to the simulation value of the real power, the real power is estimated as the parameter of the measurement.

When there is no parameter having similarity higher than a reference value, the parameter of the measurement value may not be decided. In this case, the simulation value generation unit 120 regenerates the simulation values. In regenerating the simulation values, the simulation value generation unit 120 may make some change to the environment information and the system condition information which are used for initially generating the simulation values (for example, may increase or decrease wind speed, which is a kind of environment information, by 5%). Thereafter, the re-comparing, the re-deciding the similarity, the re-estimating are performed by the pattern comparison unit 130, the decision unit 140, and the sorting unit 150, respectively.

The direct mapping unit 160 may convert the MODBUS data structure into the IEC61850 data structure with reference to the parameter estimated by the sorting unit 150. Accordingly, the MODUS frame is converted into the IEC61850.

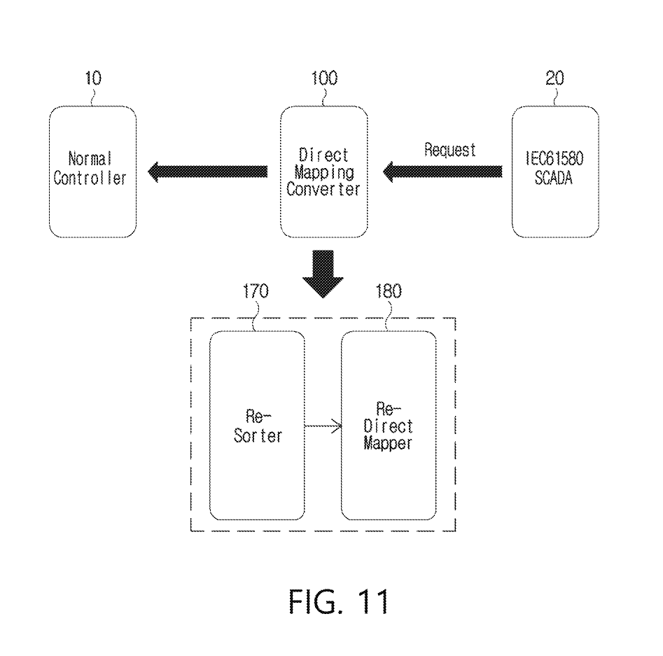

FIG. 11 is a view showing a process in which the data direct mapping system 100 transmits a command of the SCADA system 20 to the MODBUS device 10. To achieve this, the data direct mapping system 100 includes a re-sorting unit 170 and a re-direct mapping unit 180.

Since the command of the SCADA system 20 meets the IEC61850 standard, the re-sorting unit 170 may grasp what parameter is the target of the command based on contents recorded on the frame.

The re-direct mapping unit 180 may convert the command from the IEC61850 format into the MODBUS format, and transmit the command to the MODBUS device 10.

The direct mapping process for converting the MODBUS data into the IEC61850 data based on the machine learning, and the re-direct mapping process for converting the IEC61850 command into the MODBUS command according to exemplary embodiments have been described up to now.

In the above-described exemplary embodiment, in generating the simulation values for machine learning, external information (environment information, etc.) is used. This is to increase a matching rate when comparing the patterns of the measurement values and the patterns of the simulation values.

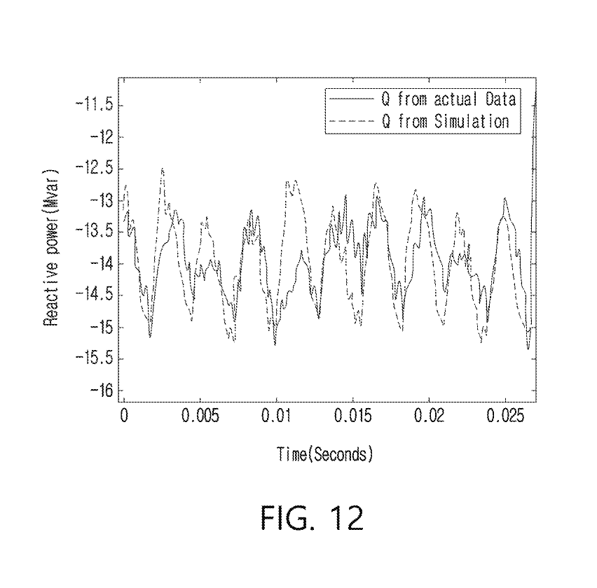

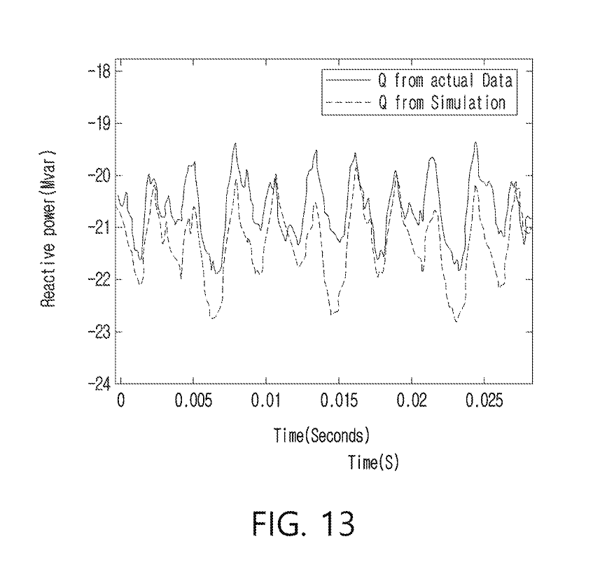

FIG. 12 is a graph comparing patterns of a simulation value and a measurement value regarding a Q factor when external information is not considered, and FIG. 13 is a graph comparing patterns of a simulation value and a measurement value regarding a Q factor when wind direction information is considered as external information. As shown in FIGS. 12 and 13, when the external information such as wind direction information is considered, the pattern matching rate increases and thus it is possible to estimate the parameter more exactly.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A data direct mapping method comprising:
generating a simulation value based on external information;
estimating a parameter indicated by a measurement value through machine learning using the measurement value outputted from a generating device and the generated simulation value; and
converting a data structure of the measurement value with reference to the estimated parameter.

2. The data direct mapping method of claim 1, wherein the external information comprises at least one of environment information and a system condition.

3. The data direct mapping method of claim 1, wherein the estimating comprises:
comparing a pattern of the measurement value and a pattern of the simulation value; and
estimating, as the parameter of the measurement value, a parameter indicated by a simulation value having highest pattern similarity, which is above a reference value, with respect to the measurement value.

4. The data direct mapping method of claim 3, further comprising, when there is no simulation value having pattern similarity higher than the reference value with respect to the measurement value, re-generating a simulation value of machine learning and re-estimating a parameter.

5. The data direct mapping method of claim 4, wherein the re-generated simulation value is re-generated by making change to the external information which is used for the already generated simulation value.

6. The data direct mapping method of claim 1, wherein the converting comprises converting a data structure of the measurement value into a data structure which is defined in a standard for the estimated parameter.

7. The data direct mapping method of claim 1, further comprising:
receiving a command;
grasping a corresponding parameter based on contents of the received command; and
converting a format of the command with reference to the grasped parameter.

8. A data direct mapping system comprising:
a generation unit configured to generate a simulation value based on external information;
a sorting unit configured to estimate a parameter indicated by a measurement value through machine learning using the measurement value outputted from a generating device and the simulation value; and
a direct mapping unit configured to convert a data structure of the measurement value with reference to the estimated parameter.
